(19) United States
(12) Patent Application Publication
(10) Pub. No.: US 2025/0074824 A1
(43) Pub. Date: Mar. 6, 2025

(54) WELLBORE CEMENT STRUCTURES AND RELATED COMPOSITIONS

(71) Applicant: SAUDI ARABIAN OIL COMPANY, Dhahran (SA)

(72) Inventors: Elizabeth Q. CONTRERAS, Houston, TX (US); Kenneth D. JOHNSON, Tomball, TX (US); Roland F. MARTINEZ, Katy, TX (US); Thomas HEINOLD, Dhahran (SA)

(73) Assignee: SAUDI ARABIAN OIL COMPANY, Dhahran (SA)

(21) Appl. No.: 18/458,917

(22) Filed: Aug. 30, 2023

(51) Int. Cl. C04B 24/28; C04B 14/06; C09K 8/487

(52) U.S. Cl. CPC C04B 24/287; C04B 14/06; C09K 8/487; C04B 2103/22; C04B 2103/408; C04B 2103/46; C04B 2103/50

(57) ABSTRACT

Compositions and methods including a polyaramid-reinforced cement. The polyaramid-reinforced cement may comprise a cement at 100% by weight of blend (bwob); a polyaramide polymer at 0.01% weight of the cement (bwob) to 80% bwob; and water at 30% bwob to 70% bwob. The polyaramid-reinforced cement may be used to produce a cement structure within a wellbore.

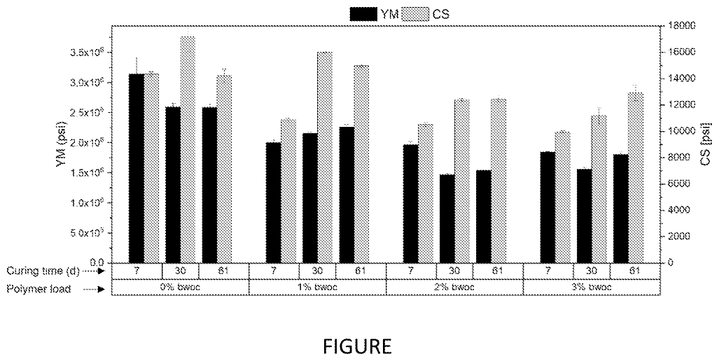

### FIELD OF THE DISCLOSURE

Embodiments in accordance herewith the present disclosure generally relate to cement compositions, and cement compositions and methods related to wellbore cement structures.

### BACKGROUND OF THE DISCLOSURE

Hydrocarbons that are produced from subterranean formations typically flow from the formations to the surface via wellbores drilled from the surface that intersect the formations. Most wellbores are lined with cement casing and strings of production tubing inserted within the casing that are for conveying the hydrocarbons to the surface. The casing is usually bonded to the inner surface of the wellbore with a cement that is injected into an annulus that is between the casing and wellbore. In addition to anchoring the casing within the wellbore, the cement also isolates adjacent zones within the formation from one another. Without the cement isolating these adjacent zones, fluids from the different zones, which are sometimes different, could become mixed in the annular space between the casing and wellbore wall.

The cement also prevents hydrocarbon fluid from flowing uphole from a hydrocarbon producing zone to the surface and in the annulus between the casing and the wellbore wall. Without the cement, or in instances when cement has failed, hydrocarbons are known to migrate to the surface and then present a safety hazard to operations personnel.

In sum, cement slurries used in the oil and gas industry include primary, remedial, squeeze, and plug cementing techniques to place cement sheaths, for instance, in an annulus between a tubular (e.g., a casing) and a wall of the wellbore, for well repairs, well stability, or for well abandonment (i.e., sealing an old well to eliminate safety hazards). These cement slurries should be able to consistently perform throughout operations (e.g., pumping) and over a wide range of temperatures and conditions as cement set in an oil and gas well may be vulnerable to radial stresses imposed by pressure and temperature fluctuations. Such vulnerability, depending on its severity, can result in mechanical failure. After mechanical failure, an expensive remedial operation like squeezing resin or micro-cement may be required to repair cracks in the wellbore cement sheath. Inadequate sealing of the original cracks or inadequate remedial operations may cause a fire hazard, an environmental hazard, a lack of zonal isolation, or a loss of pressure behind casing. Depending on the severity, these risks may lead to catastrophic accidents, failures, or well-abandonment.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a polyaramid-reinforced cement is provided. The polyaramid-reinforced cement includes a cement at 100% by weight of blend (bwob); a polyaramid polymer at an active 0.01% bwob to 80% bwob; and water at about 30% bwob to about 70% bwob.

According to another embodiment consistent with the present disclosure, a method is provided including introducing a polyaramid-reinforced cement into a wellbore and curing the polyaramid-reinforced cement in the wellbore to form a cement structure there. The polyaramid-reinforced cement includes a cement at 100% bwob; a polyaramid polymer at 0.01% bwob to 80% bwob; and water at about 30% bwob to 70% bwob.

According to another embodiment consistent with the present disclosure, a method is provided including mixing a polyaramid-reinforced cement including a cement at 100% bwob; a polyaramid polymer at 0.01% bwob to 80% bwob; and water at about 30% bwob to 80% bwob. The polyaramid polymer is hydrated with the water. The polyaramid-reinforced cement is introduced into a wellbore and cured in the wellbore to form a cement structure.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

The FIGURE illustrates a chart showing mechanical properties of polyaramid-reinforced cements of the present disclosure compared to control cement.

### DETAILED DESCRIPTION

Embodiments of the present disclosure will now be described in detail with reference to the accompanying FIGURE. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying FIGURE may vary without departing from the scope of the present disclosure.

Embodiments in accordance with the present disclosure generally relate to cement compositions, and cement compositions and methods related to wellbore cement structures. More specifically, the present disclosure provides high-performance polyaramid-reinforced cements for use in the construction of oil and gas wells and in cementitious construction materials. The polyamide-reinforced cements have enhanced mechanical properties and compensate for radial displacement of a cement sheath, for example.

### Definitions

As used herein, the term “polyaramid-reinforced cement,” and grammatical variants thereof, refers to a cement composition comprising polyaramid polymers, cement, water, and optional additives.

As used herein, the term “polyaramid” or “polyaramid polymer.” and grammatical variants thereof, refers to a polymer formed from an aromatic amide.

As used herein, the terms “superabsorbent polymer” or “SAP.” and grammatical variants thereof, refers to a water-absorbing hydrophilic homopolymer or copolymer that can absorb and retain large amounts of liquid relative to its mass.

As used herein, the term “crenate,” and grammatical variants thereof, refers to the formation of an uneven, notched (e.g., scalloped) surface caused by osmotic water loss (or lack of water absorption).

As used herein, the term “curing.” and grammatical variants thereof, refers to providing adequate moisture, temperature, pressure, and time to allow polyaramid-reinforced cement to achieve desired properties (such as hardness) for its intended use through one or more reactions between at least the polyaramid, cement, and water.

### Polyaramid-Reinforced Cement Compositions:

Polyaramid polymers are high-density, bio-inspired polymers and, as shown herein, can enhance cement integrity due to its many unique features. Indeed, these polyaramid-reinforced cements exhibit enhanced mechanical properties, displaying high-strength, high-elasticity to reduce plastic deformation, and high compressive strength, which is essential to prolong the lifespan of wellbore cement sheaths. Advantageously, the mechanical and rheological properties of the polyaramid-reinforced cements of the present disclosure are suitable for withstanding the cyclic loading placed upon wellbore cement sheaths due to dramatic changes in pressure and temperature during production operations and for providing long-term zonal isolation in oil and gas wells. Further, the polyaramid-reinforced cements of the present disclosure are in the form of liquid slurries that are workable and highly stable (no settling), mitigate cement strength retrogression at high temperatures and pressures, and provide long-term performance as gas-tight cement sheaths with advantageous elastic properties in subterranean formations.

The polyaramid-reinforced cement of the present disclosure comprises polyaramid polymers, cement, water, and optional additives.

The polyaramid-reinforced cements may comprise any polyaramid, provided that it imparts the various mechanical and rheological qualities described herein. Examples of suitable polyaramid polymers include, but are not limited to, aromatic monomers and aliphatic monomers, such as poly-p-phenyleneteraphthalamid (i.e., Kevlar®), poly-m-phenyleneteraphthalamid (i.e., Nomex®), and nylons, and the like, and any combination thereof.

The polyaramid polymers may be present in the polyaramid-reinforced cement in the range of about 0.01% bwob to 80% bwob (or 1% bwob to 5% bwob, or 5% bwob to 10% bwob, or 1% bwob to 3% bwob, or 5% bwob to 15% bwob, or 10% bwob to 20% bwob, or 15% bwob to 30% bwob, or 25% bwob to 50% bwob, or 45% bwob to 75% bwob, or 60% bwob to 80% bwob), encompassing any value and subset therebetween.

The cement for inclusion in the polyaramid-reinforced cement of the present disclosure may include Portland cement, siliceous fly ash, calcareous fly ash, slag cement, silica fume, silica sand, any known cementitious material or geopolymer, and the like, and any combination thereof. The cement may be a type of cement as classified by ASTM, such as Type I, II, III, or V, and any type of cement as classified by API, such as Class A, C, G, or H. In preferred embodiments, the cement is Portland cement, as described by API Specification 10A. The cement may be present in the polyaramid-reinforced cement in an amount of 100% bwob (e.g., in the range of about 40% bwob to about 60% bwob) of the polyaramid-reinforced cement.

The water in the polyaramid-reinforced cement described herein may include, but is not limited to, distilled water, deionized water, tap water, brackish water, formation water, produced water, raw seawater, filtered seawater, and the like, and any combination thereof. For instance, the water may include freshwater or seawater, natural or synthetic brine, or salt water.

The water may be present in the polyaramid-reinforced cement in the range of 30% bwob to 80% bwob polyaramid-reinforced cement (or 40% bwob to 80% bwob, or 60% bwob to 80% bwob), encompassing any value and subset therebetween.

The polyaramid-reinforced cement may also comprise one or more additives, inorganics, and polymers including, but not limited to, a dispersant, a cement hydration retarder, an expanding agent, a fluid loss control agent, a defoamer, silica, and the like, and any combination thereof.

The dispersant may be present in the polyaramid-reinforced cement to reduce the viscosity of the cement and improve fluid flow characteristics. Suitable dispersants may include, but are not limited to, sulfonated-formaldehyde-based dispersants (e.g., sulfonated acetone formaldehyde condensate), polycarboxylated ether dispersants, polyunsulfonated naphthalene dispersants, hydroxycarboxylic acid dispersants, and the like, and any combination thereof.

The dispersant may be present in the polyaramid-reinforced cement in the range of 0.01% bwob to 5% bwob (or 0.01% bwob to 0.1% bwob, or 1% bwob to 1.5% bwob, or 3% bwob to 4% bwob, or 3% bwob to 5% bwob), encompassing any value and subset therebetween.

Cement hydration retarders are chemical agents that increase the thickening time of cements to enable proper placement of the cement within a wellbore. Examples of suitable retarders may include, but are not limited to, lignosulfonates, hydroxycarboxylic acids, starches, sugars, chelates, cellulose derivatives, the like, and any combination thereof.

Cement hydration retarders may be present in the polyaramid-reinforced cements described herein in the range of 0.01% bwob to 5% bwob (or 1% bwob to 4% bwob, or 3% bwob to 5% bwob), encompassing any value and subset therebetween.

Expanding agents may be used to control the permeability of the polyaramid polymers within the polyaramid-reinforced cement, thus controlling the size of the polyaramid polymer vesicles and the uptake of water. Expanding agents may include, but are not limited to, calcium sulfoaluminate, magnesium oxide, and the like, and any combination thereof.

Expanding agents may be present in the polyaramid-reinforced cements in the range of 0.1% bwob to 5% bwob (or 0.5% bwob to 1% bwob, or 1% bwob to 2% bwob, or 3% bwob to 5% bwob), encompassing any value and subset therebetween.

Examples of fluid loss control agents may include, but are not limited to, HEC, polyvinyl alcohol, polyethylencimine, polyalkanolamines, polyacrylamides, liquid latex, 2-acrylamido-2-methylpropane sulfonic acid (AMPS), a carboxylic fatty acid having from 16 to 18 carbon atoms (e.g., palmitic acid, palmitoleic acid, vaccenic acid, oleic acid, elaidic acid, linoleic acid, α-linolenic acid, γ-linolenic acid, and stearidonic acid), bentonite, the like, and any combination thereof.

Fluid loss control agents may be present in the polyaramid-reinforced cements in the range of 0.1% bwob to 2% bwob (or 0.1% bwob to 0.25% bwob, or 0.25% bwob to 0.5% bwob, or 0.5% bwob to 1% bwob), encompassing any value and subset therebetween.

Latex and latex stabilizers may be included in the polyaramid-reinforced cements to prevent or remove large air inclusions at the cement's surface. Examples of suitable latexes include, but are not limited to, acrylate latex, styrene butadiene copolymer latex (SBR), carboxylated functionalized latex (e.g., liquid or dry products), sulfonated-functionalized latex, (e.g., liquid or dry products), and the like, and any combination thereof. Latex and latex stabilizers may be present in the polyaramid-reinforced cements in the range of about 1.5 gallons per sack of cement (GPS) to 10 GPS (or 1% GPS to 10% GPS, or 1% GPS to 5% GPS, or 2% GPS to 10% GPS), encompassing any value and subset therebetween.

Defoamers may be included in the polyaramid-reinforced cements to prevent or remove large air inclusions at the cement surface or for rapid foam collapse. Examples of suitable defoamers include, but are not limited to, alcohols (e.g., cetostearyl alcohol), insoluble oils (e.g., castor oil), stearates, polydimethylsiloxanes and other silicone derivatives, ethers, glycols, and the like, and any combination thereof.

Defoamers may be present in the polyaramid-reinforced cements in the range of 0.005% GPS to 1% GPS (or 0.01% GPS to 1% GPS, or 0.01% GPS to 0.05% GPS, or 0.5% GPS to 1% GPS), encompassing any value and subset therebetween.

Silica may be included in the polyaramid-reinforced cements to prevent strength retrogression at temperatures above 230° F. (110° C.), improve mechanical properties, such as compressive strength, bond strength, and abrasion resistance. Suitable silica may include, but are not limited to, natural silica sand, ordinary silica sand, refined silica sand, high-purity silica sand, fused silica sand, silica flour and micro silica, and the like, and any combination thereof.

The silica may be present in the polyaramid-reinforced cements in the range of 30% bwob to 50% bwob (or 30% bwob to 40% bwob, or 40% bwob to 50% bwob, or 30% bwob to 35% bwob), encompassing any value or subset therebetween.

### Polyaramid-Reinforced Cement Properties:

After mixing, the bulk density (grams per milliliter (g/ml)) of the polyaramid-reinforced cements of the present disclosure may be in the range of 1.5 g/ml to 2.2 g/ml (or 1.5 g/ml to 1.65 g/ml, or 1.6 g/ml to 1.64 g/ml, or 1.7 g/ml to 2.0 g/ml), encompassing any value and subset therebetween.

After mixing, the polyaramid-reinforced cements of the present disclosure are introduced into a wellbore as a slurry, and the slurry exhibits favorable or improved rheological properties compared to cement slurries lacking polyaramid polymers. Such rheological properties include viscosity and elasticity.

The viscosity of the polyaramid-reinforced cements should be such that they are capable of controlling fluid loss into a formation within a wellbore and maintaining suspension of solids within the polyaramid-reinforced cements, among other functions.

The viscosity of the polyaramid-reinforced cements at 72° F. and a shear rate of 300 rpm may be in the range of 250 centipoise (cp) to 400 cp (or 250 cp to 300 cp, or 300 cp to 350 cp, or 350 cp to 400 cp, or 270 cp to 390 cp), encompassing any value and subset therebetween.

The viscosity of the polyaramid-reinforced cements at 180° F. and a shear rate of 300 rpm may be in the range of 150 cp to 350 cp (or 150 cp to 200 cp, or 200 cp to 250 cp, or 250 cp to 300 cp, or 350 cp to 400 cp, or 170 cp to 315 cp), encompassing any value and subset therebetween.

Fluid loss (i.e., the loss of water from the cement slurry) may result upon contact with permeable subterranean formations and zones within the wellbore. Excessive fluid loss can cause, among other things, a cement slurry to be prematurely dehydrated, thereby limiting the amount of cement that can be pumped and also decreasing compressive strength and bond strength. Fluid loss herein is measured per API RP 10B-2. The thickening time of a cement refers to a measure of the time during which a cement slurry remains in a fluid state and is capable of being pumped. Thickening time is assessed under simulated downhole conditions using a consistometer that plots the consistency of a cement slurry over time at the anticipated temperature and pressure conditions (i.e., high-temperature and high-pressure). Accordingly, thickening time may be used interchangeably with pumping (or pumpability) time.

Herein, the thickening time is reported as the time from when temperature and pressure is applied to the cement slurry until the end point of 70 Bearden units (BC); the thickening time temperature (simulated bottom hole circulating temperature) was 300° F. and the thickening time pressure (simulated bottom hole pressure) was 7,500 psi.

After placement in the wellbore, the polyaramid-reinforced cement may cure over time (e.g., to form a cured cement). Curing may be a passive step where no physical action is needed (such as cement that cures in ambient conditions when untouched). In contrast, cement hydration refers to merely allowing cement to achieve a moisture condition appropriate for its intended use. Hydrating the polyaramid-reinforced cement may refer to passively allowing time to pass under suitable conditions upon which the polyaramid-reinforced cement may set by allowing one or more reactions between at least water and the multiple crystalline phases present in unhydrated and set cement; and between the polyaramid, water, cement material. Suitable conditions may be any time, temperature, pressure, humidity, and other appropriate conditions known in the cement industry to cure a cement composition. Suitable curing conditions may be ambient conditions or at elevated temperatures and pressures. Alternatively, curing may also be achieved by actively hardening or curing the cement slurry through manipulation of the environmental conditions using chemical admixtures in the cement slurry to facilitate reactions between the water and cement precursor, a combination of these, or other such means.

In particular, in one or more instances, the polyaramid-reinforced cement of the present disclosure is cured at a temperature of 300° F. (150° C.) and a pressure of 7,500 psi for a time period of from 7 days to 61 days. Temperatures may range from about 180° F. to about 400° F. and pressures may range from about 1,000 psi to about 10,000 psi, encompassing any value and subset therebetween.

Free water is water that is not required for cement hydration and is evaluated herein according to API RP 10B. In cementing operations, free water is undesirable because it can form channels through a curing cement and provide a conduit for fluid migration from a subterranean source. The free water of the polyaramid-reinforced cements of the present disclosure (testing upon S1-S3 as described in the Examples below) is 0%.

Once the polyaramid-reinforced cement is cured, the cured cement constitutes a cement structure within the wellbore. The cement structure (sheath) will have various properties that indicate the physical strength of the cement structure. For instance, confined Young's modulus (YM) measures the ratio of the stress (force per unit area) along an axis to the strain (ratio of deformation over initial length) along that axis. Thus, Young's modulus can be used to show the elasticity or stiffness of the cement structure within the wellbore and gives insight into the mechanical resilience of the cement structure. Poisson's ratio is a measure of transverse strain to axial strain, and measures the deformation capacity of the cement structure. The greater the deformation capacity (that is, the greater Poisson's ratio), the less likely the cement structure will be damaged as temperature and pressure changes within the wellbore. Confined compressive strength (CS) is the capacity of a cement to withstand loads before fracture. CS is measured from the failure load divided by the cross-sectional area resisting the load and reported in psi.

In one or more embodiments, the Young's modulus, Poisson's ratio, and compressive strength of the cured polyaramid-reinforced cement of the present disclosure was measured 7 days after curing under tri-axial loading of 100 psi at room temperature (RT) (20-25° C.). The Young's modulus and Poisson's ratio were measured per ASTM C469/C469M-14 and the compressive strength was measured per ASTM C109/C109M-20, all after curing the corresponding polyaramid-reinforced cement at 300° F. and 7,500 psi for 7 days (see Examples below).

In one or more instances, the YM of the cured polyaramid-reinforced cements of the present disclosure is in the range of 1.0×10⁶ psi to 2.5×10⁶ psi (or 1.3×10⁶ psi to 2.3×10⁶ psi, or 1.6×10⁶ psi to 2.2×10⁶ psi), encompassing any value and subset therebetween.

In one or more aspects, the Poisson's ratio of the polyaramid-reinforced cements described herein is in the range of 0.15 to 0.3 (or 0.15 to 0.2, or 0.2 to 0.25, or 0.25 to 0.3), encompassing any value and subset therebetween.

In one or more aspects, the compressive strength (CS, measured by ASTM C109/C109M-20) of the polyaramid-reinforced cements is in the range of 3,500 psi to 18,000 psi (or 3,500 psi to 10,000 psi, or 10,000 psi to 15,000 psi, or 15,000 psi to 18,000 psi, or 10,000 psi to 16,000 psi), encompassing any value and subset therebetween.

### Nonlimiting Example Embodiments

Embodiments disclosed herein include:
Embodiment A: A polyaramid-reinforced cement comprising: a cement at 100% bwob; a polyaramide polymer at 0.01% bwob to 80% bwob; and water at 30% bwob to 70% bwob.
Embodiment B: A method comprising: introducing a polyaramid-reinforced cement into a wellbore, the polyaramid-reinforced cement comprising: a cement at 100% bwob; a polyaramid polymer at 0.01% bwob to 80% bwob; and water at 30% bwob to 70% bwob; and curing the polyaramid-reinforced cement in the wellbore, thereby forming a cement structure therein.
Embodiment C: A method comprising: mixing a polyaramid-reinforced cement, the polyaramid-reinforced cement comprising: a cement at 100% bwob; a polyaramide polymer at 0.01% bwob to 80% bwob; and water at 30% bwob to 70% bwob; hydrating the polyaramid polymer with the water; introducing the polyaramid-reinforced cement into a wellbore; and curing the polyaramid-reinforced cement in the wellbore, thereby forming a cement structure therein.

Each of embodiments A through C may have one or more of the following additional elements in any combination:
Element 1: wherein the polyaramid-reinforced cement has a fluid loss of less than 75 ml/30 min.
Element 2: wherein the polyaramid-reinforced cement has a sedimentation of less than 5 pfc.
Element 3: wherein the polyaramid-reinforced cement has a thickening time of less than 700 minutes at a temperature of 300° F. and a pressure of 7,500 psi.
Element 4: wherein the polyaramid-reinforced cement has a free water content of 0%.
Element 5: wherein the polyaramid-reinforced cement further comprises a dispersant in the range of 0.01% bwob to 5% bwob.
Element 6: wherein the polyaramid-reinforced cement further comprises a hydration retarder in the range of 0.01% bwob to 5% bwob.
Element 7: wherein the polyaramid-reinforced cement further comprises an expanding agent in the range of 0.1% bwob to 5% bwob.
Element 8: wherein the polyaramid-reinforced cement further comprises a fluid loss control agent in the range of 0.1% bwob to 2% bwob.
Element 9: wherein the polyaramid-reinforced cement further comprises a defoamer in the range of 0.005% GPS to 1% GPS.
Element 10: wherein the polyaramid-reinforced cement further comprises silica in the range of 30% bwob to 50% bwob.
Element 11: wherein the polyaramid-reinforced cement further comprises: a dispersant in the range of 0.01% bwob to 5% bwob; a hydration retarder in the range of 0.01% bwob to 5% bwob; an expanding agent in the range of 0.1% bwob to 5% bwob; a fluid loss control agent in the range of 0.1% bwob to 2% bwob; a defoamer in the range of 0.005% GPS to 1% GPS; and a silica sand in the range of 30% bwob to 50% bwob.

By way of non-limiting example, exemplary combinations applicable to A through C include one, more, or all of Elements 1-11, without limitation.

### EXAMPLES

In the following examples, various experiments were performed and measurements taken to evaluate and validate the thermal post-treatment methodology of delayed coke described herein, such that the treated delayed coke exhibits mechanical properties suitable for use as proppant particulates during hydraulic fracturing operations.

### Example 1: Preparation of Polyaramid-Cement Samples

In this Example, one (1) control (C1) and three (3) polyaramid-cement samples (S1-S3) were prepared having the compositions provided in Table 1; the density for each sample is also provided in Table 1:

TABLE 1

| Sample | C1 | S1 | S2 | S3 |
|---|---|---|---|---|
| Portland Cement (% bwob) | 100 | 100 | 100 | 100 |
| Silica (% bwob) | 35 | 35 | 35 | 35 |
| Water (% bwob) | 100 | 100 | 100 | 100 |
| Expanding Agent (% bwob) | 1 | 1 | 1 | 1 |
| Polyaramid (% bwob) | 0 | 1 | 2 | 3 |
| Fluid Loss Control Agent 1 (% | 0.25 | 0.25 | 0.43 | 0.1 |
| bwob) | | | | |
| Fluid Loss Control Agent 2 (% | 0.51 | 0.51 | 0.75 | 1.2 |
| bwob) | | | | |
| Hydration Retarder 1 (% bwob) | 0.5 | 0.5 | 0.05 | 0.5 |
| Hydration Retarder 2 (% bwob) | 0.1 | 0.1 | 0.1 | 0.1 |
| Defoamer (GPS) | 0.01 | 0.01 | 0.01 | 0.01 |
| Density (lbs/gal) | 15.8 | 15.8 | 15.8 | 15.8 |

It is to be noted that challenges, such as cement strength retrogression, can be mitigated when cements are cured at temperatures >93° C. (200° F.). With more challenging wells being drilled under challenging conditions, curing parameters were used to simulate real-world scenarios to demonstrate reliability of the polyaramid-reinforced cements described herein.

Samples C1 and S1-S3 were cured under in situ conditions. The samples were poured into brass molds, placed into a pressurized curing chamber to eliminate air entrainment, and allowed to cure for at least 7 days and up to 60 days at 300° F. and 7,500 psi pressure. The sample ends were trimmed to 1:2 following ASTM C617 standards to undergo tri-axial loading testing at RT and 1000 psi pressure, as described below.

### Example 2: Mechanical Properties of Samples C1 and S1-S3

As provided in Example 1, Samples C1 and S1-S3 were cured at 300° F. and 7,500 psi confining pressure for at least 7 days and up to 61 days. Mechanical properties such as confined Young's modulus, confined compressive strength, and Poisson's ratio were determined. The quality of cement is an integral part of well integrity, particularly at extreme temperatures and pressures. YM and CS were measured to evaluate cement durability and integrity after 7 days of curing, 30 days of curing, and 61 days of curing.

YM and CS were measured at RT, with tri-axial confining pressures of 1,000 psi to determine fatigue behavior; only the elasticity region of the cement samples was evaluated. To find the elastic region, uni-stress cycling is calculated by measuring the confined failure point of the 7-day cured samples, calculating a 30% failure point representing the elastic region, and measuring confined YM of the subsequent 30-day and 61-day cured samples. The testing procedure is shown below in Table 2, where Cp is confined pressure, “n₁” are the 7-day cured samples, “n” is each of the 30- and 61-day samples, and “[CS]” is the compressive strength.

TABLE 2

At room temperature,
Sample n₁
Cp min = 1000 psi
Failure point rate = 0.694 Pa = 290 psi to failure [CS]
Subsequent samples n,
Cp min = 1,000 psi
Unistress Amp = 5 rate = 0.694 Pa = 30% [CS] cycle = 5
Cp min = 1,000 psi
Failure point rate = 0.694 Pa = 290 psi to failure [CS]

The results are shown in Table 3 for confined YM, confined CS, and calculated Poisson's ratio:

TABLE 3

| Sample | C1 | S1 | S2 | S3 |
|---|---|---|---|---|
| Final Curing Time (days) | 7 | 7 | 7 | 7 |
| Compressive Strength | 14,340 | 10,870 | 10,520 | 9,960 |
| (psi) | | | | |
| Young's Modulus (psi) | 3.14 × 10⁶ | 2.00 × 10⁶ | 1.97 × 10⁶ | 1.85 × 10⁶ |
| Poisson's Ratio | 0.2 | 0.2 | 0.21 | 0.2 |
| Final Curing Time (days) | 30 | 30 | 30 | 30 |
| Compressive Strength | 17,170 | 16,000 | 12,390 | 11,180 |
| (psi) | | | | |
| Young's Modulus (psi) | 2.59 × 10⁶ | 2.16 × 10⁶ | 1.47 × 10⁶ | 1.56 × 10⁶ |
| Poisson's Ratio | 0.25 | 0.23 | 0.24 | 0.25 |
| Final Curing Time (days) | 61 | 61 | 61 | 61 |
| Compressive Strength | 14,240 | 14,970 | 12,450 | 12,920 |
| (psi) | | | | |
| Young's Modulus (psi) | 2.58 × 10⁶ | 2.26 × 10⁶ | 1.54 × 10⁶ | 1.80 × 10⁶ |
| Poisson's Ratio | 0.25 | 0.23 | 0.22 | 0.21 |

The YM and CS are further depicted in the FIGURE. As shown, statistically significant improvements in YM and CS are shown, demonstrating improved elasticity, of the cement comprising polyaramid polymers compared to the control (no polyaramid polymers). As shown in the FIGURE, sample C1 maintains an essentially constant value for compressive strength as curing continues past 7 days (i.e., hydration before curing); it also becomes less elastic (more brittle) making it more susceptible to fractures as curing continues past 7 days. Comparatively, and as shown in the FIGURE, polyaramid-reinforced cement samples S1-S3 show increased strength over the span of 61 curing days and has favorably low Young's modulus, which may be attributed to the discrete control of water availability in controlling cement hydration by slowly releasing polyaramid polymer-bound water to maintain a consistent w/c value. Indeed, polyaramid-reinforced cements continue to impart elasticity without sacrificing compressive strength.

### Example 3: Rheological Viscosity Measurements

In this Example, viscosity rheological measurements for samples C1 and S1-S3 were determined in accordance with API RP 10B2. Plastic viscosity (“PV”) was determined based on rheology measurements taken using a viscometer at 72° F. and 180° F., and at shear rates of 3 rpm, 6 rpm, 100 rpm, 200 rpm, 300 rpm, and 600 rpm. The PV represents the viscosity of a fluid when extrapolated to infinite shear rate and is determined based on the difference between the 600 rpm reading and the 300 rpm reading. Further, no sedimentation was visually observed. The results of the rheology measurements are shown in Table 4:

TABLE 4

| Sample | C1 | S1 | S2 | S3 |
|---|---|---|---|---|
| Temperature (° F.) | 72 | 72 | 72 | 72 |

| | | | | | |
|---|---|---|---|---|---|
| 3 | rpm | 2 | 7 | 11 | 16 |
| 6 | rpm | 3 | 10 | 16 | 27 |
| 100 | rpm | 46 | 119 | 178 | 272 |
| 200 | rpm | 87 | 205 | 285 | 378 |
| 300 | rpm | 126 | 274 | 365 | 386 |

| | | | | |
|---|---|---|---|---|
| Temperature (° F.) | 180 | 180 | 180 | 180 |

| | | | | | |
|---|---|---|---|---|---|
| 3 | rpm | 1 | 3 | 2 | 4 |
| 6 | rpm | 1 | 5 | 5 | 8 |
| 100 | rpm | 16 | 66 | 79 | 135 |
| 200 | rpm | 38 | 123 | 148 | 228 |
| 300 | rpm | 65 | 171 | 212 | 313 |

Improved ductility of ordinary Portland cement may be achieved by engineering highly crosslinked polyaramids with dynamic molecular sections, for example. When added to cement, the inclusion of polyaramid polymers show significant improvements to elasticity and performance under wellbore conditions, particularly at high temperature and high pressure conditions, with a reduction in plastic deformation and a resistance to fractures and failure compared to conventional cement systems based on permanent strain measurements.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including”, “comprises”, and/or “comprising”, and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A polyaramid-reinforced cement comprising:
a cement at 100% bwob;
a polyaramide polymer at 0.01% bwob to 80% bwob; and
water at 30% bwob to 70% bwob.

2. The polyaramid-reinforced cement of claim 1, wherein the polyaramid-reinforced cement has a free water content of 0%.

3. The polyaramid-reinforced cement of claim 1, wherein the polyaramid-reinforced cement further comprises a dispersant in the range of 0.01% bwob to 5% bwob.

4. The polyaramid-reinforced cement of claim 1, wherein the polyaramid-reinforced cement further comprises a hydration retarder in the range of 0.01% bwob to 5% bwob.

5. The polyaramid-reinforced cement of claim 1, wherein the polyaramid-reinforced cement further comprises an expanding agent in the range of 0.1% bwob to 5% bwob.

6. The polyaramid-reinforced cement of claim 1, wherein the polyaramid-reinforced cement further comprises a fluid loss control agent in the range of 0.1% bwob to 2% bwob.

7. The polyaramid-reinforced cement of claim 1, wherein the polyaramid-reinforced cement further comprises a defoamer in the range of 0.005% GPS to 1% GPS.

8. The polyaramid-reinforced cement of claim 1, wherein the polyaramid-reinforced cement further comprises a silica in the range of 30% bwob to 50% bwob.

9. A method comprising:
introducing a polyaramid-reinforced cement into a wellbore, the polyaramid-reinforced cement comprising:
a cement;
a polymer component comprising a polyaramid polymer at 0.01% by weight of dry cement (bwob) to 8% bwob; and
water; and
curing the polyaramid-reinforced cement in the wellbore, thereby forming a cement structure therein.

10. The method of claim 9, wherein the polyaramid-reinforced cement has a free water content of 0%.

11. The method of claim 9, wherein the polyaramid-reinforced cement further comprises a dispersant in the range of 0.01% bwob to 5% bwob.

12. The method of claim 9, wherein the polyaramid-reinforced cement further comprises:
a dispersant in the range of 0.01% bwob to 5% bwob;
a hydration retarder in the range of 0.01% bwob to 5% bwob;
an expanding agent in the range of 0.1% bwob to 5% bwob;
a fluid loss control agent in the range of 0.1% bwob to 2% bwob;
a defoamer in the range of 0.005% GPS to 1% GPS; and
a silica sand in the range of 30% bwob to 50% bwob.

13. A method comprising:
mixing a polyaramid-reinforced cement, the polyaramid-reinforced cement comprising:
a cement;
a polymer component comprising a polyaramide polymer at 0.01% by weight of cement (bwob) to 80% bwob; and
hydrating the polyaramid polymer with water;
introducing the polyaramid-reinforced cement into a wellbore; and
curing the polyaramid-reinforced cement in the wellbore, thereby forming a cement structure therein.

14. The method of claim 13, wherein the polyaramid-reinforced cement has a free water content of 0%.

15. The method of claim 13, wherein the polyaramid-reinforced cement further comprises a dispersant in the range of 0.01% bwob to 5% bwob.

16. The method of claim 13, wherein the polyaramid-reinforced cement further comprises:
a dispersant in the range of 0.01% bwob to 5% bwob;
a hydration retarder in the range of 0.01% bwob to 5% bwob;
an expanding agent in the range of 0.1% bwob to 5% bwob;
a fluid loss control agent in the range of 0.1% bwob to 2% bwob;
a defoamer in the range of 0.005% GPS to 1% GPS; and
a silica in the range of 30% bwob to 50% bwob.

17. The method of claim 9, wherein the polymer component consists of polyaramid polymer at 0.01% by weight of dry cement (bwob) to 80% bwob.

18. The method of claim 13, wherein the polymer component consists of polyaramid polymer at 0.01% by weight of dry cement (bwob) to 80% bwob.

19. The method of claim 9, wherein the polymer component comprises a polymer selected from the group consisting of poly-p-phenyleneteraphthalamid and poly-m-phenyleneteraphthalamid.

20. The method of claim 13, wherein the polymer component comprises a polymer selected from the group consisting of poly-p-phenyleneteraphthalamid and poly-m-phenyleneteraphthalamid.
